(19) United States
(12) Patent Application Publication
(10) Pub. No.: US 2009/0225148 A1
(43) Pub. Date: Sep. 10, 2009

(54) OPTICAL WRITING HEAD AND IMAGE FORMING APPARATUS

(76) Inventors: Yukio Itami, Kanagawa (JP); Tomohiro Nakajima, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/365,423

(22) Filed: Feb. 4, 2009

(30) Foreign Application Priority Data
Mar. 10, 2008 (JP) 2008-059788

(51) Int. Cl. B41J 2/39

(52) U.S. Cl. 347/141

(57) ABSTRACT

An optical writing head includes light-emitting element array chips; a circuit board on which the light-emitting element array chips are mounted; and an imaging element array that focuses light beams emitted from the light-emitting element array chips to form optical spots. The following inequality is satisfied:

$${L}_{1} < \frac{25.4 \times N}{ρ}$$

where L₁ is an arrangement pitch [mm] between any adjacent light-emitting element array chips at normal temperature, ρ is resolution [dpi] in a main scanning direction, and N is the number of light-emitting points of each of the light-emitting element array chips.

### CROSS-REFERENCE TO RELATED APPLICATIONS

The present application claims priority to and incorporates by reference the entire contents of Japanese priority document 2008-059788 filed in Japan on Mar. 10, 2008.

### BACKGROUND OF THE INVENTION

1. Field of the Invention

The present invention relates to an optical writing head and an image forming apparatus.

2. Description of the Related Art

An electrophotographic process is known as one of image forming processes performed by image forming apparatuses.

FIG. 7 is a schematic diagram of an image forming apparatus disclosed in Japanese Patent Application Laid-open No. 2004-9655. The image forming apparatus performs an electrophotographic process in a manner described below. An electric potential is applied to an image carrier (for example, a photosensitive element) 11 by a charging unit 12 (charging process). A surface of the image carrier 11 is then irradiated with a light beam emitted from an optical writing unit (exposure unit) 13 whereby a latent image is formed on the surface (exposure process). Toner is applied to the latent image by a developing unit 14, so that a toner image is formed on the surface (developing process). The toner image is then transferred onto a recording sheet 17 by a transferring unit 15 (transferring process). The toner image is fixed to the recording sheet 17 with pressure and heat applied from a fixing unit 16 (fixing process).

The toner remaining on the image carrier 11 is removed by a cleaner unit 18, and a charged portion of the surface of the image carrier 11 is neutralized by a neutralizing unit 19. The process from the charging to the neutralization is repeated.

In recent years, size reduction of the optical writing unit 13 for digital writing has been required in accordance with size reduction of a digital image output apparatus, such as a digital copier, a printer, or a digital facsimile.

Digital writing systems can be roughly classified into two types, i.e., an optical scanning system and an array optical writing system. In the optical scanning system, an optical deflector deflects a light beam emitted from a light source such as a semiconductor laser, and a scanning imaging lens focuses the light beam thereby forming an optical spot on a scan target surface. In the array optical writing system, a light-emitting element array, such as a light-emitting diode (LED) array or an organic electroluminescence (EL) array, emits light beams, and an imaging element array focuses the light beams thereby forming optical spots on a scan target surface.

The optical scanning system has a disadvantage that the length of an optical path in the optical scanning system is long because the light beam needs to be deflected by the optical deflector for scanning. On the other hand, in the array optical writing system, the length of an optical path in the array optical writing system can be short, so that the optical writing unit 13 can be compact.

The optical writing unit 13 includes a light-emitting element array having a plurality of light-emitting elements and an imaging element array having a plurality of imaging elements.

FIG. 8 is a schematic diagram of the optical writing unit 13 in which a rod lens array 20 is used disclosed in Japanese Patent Application Laid-open No. 2004-9655. An LED array is used as the light-emitting element array. The LED array generally includes a plurality of LEDs as the light-emitting elements arranged at predetermined arrangement pitches.

FIG. 9A is a schematic diagram of the LED array disclosed in Japanese Patent Application Laid-open No. 2004-9655, FIG. 9B is a side view of the LED array shown in FIG. 9A, and FIG. 9C is a schematic diagram of a light-emitting element array chip 22 of the LED array. About several tens to a hundred of the light-emitting element array chips 22 are mounted on a substrate 21 of the LED array, and about several tens to several hundreds of light-emitting elements (LEDs) are arranged at a predetermined pitch on each of the light-emitting element array chips 22. The adjacent light-emitting element array chips 22 are mounted on the substrate 21 such that the light-emitting elements on ends of the adjacent light-emitting element array chips 22 are arranged at the predetermined pitch. Drivers 23 and a connector 24 are mounted on the substrate 21.

A rod lens array including a plurality of gradient-index rod lenses in a bundle is generally used as the imaging element array in the optical writing unit in the array optical writing system. FIG. 10 is a cross sectional view of a rod lens array disclosed in Japanese Patent Application Laid-open No. 2004-9655. In the rod lens array, rod lenses 25 are arranged in a zigzag alignment in two lines, and the rod lenses 25 are supported by side plates 26 around their circumferences. An opaque material 27 is filled and solidified between the rod lenses 25.

FIG. 11 is a schematic diagram of a roof prism lens array (RPLA) disclosed in Japanese Patent Application Laid-open No. 2004-9655. The RPLA has been proposed as the other type of imaging element array. The RPLA includes an incidence-side lens surface 28, an output-side lens surface 29, and a roof prism 30 that are integrally formed. The reference numeral 31 denotes a rib.

Japanese Patent Application Laid-open No. 2002-96496 describes that the temperature of an optical writing head arranged inside an apparatus increases from the normal temperature of 20° C. to about 60° C. FIG. 12 is a schematic diagram of an optical printer including the optical writing head, and FIG. 13 is a schematic diagram for explaining a configuration of the optical writing head, disclosed in Japanese Patent Application Laid-open No. 2002-96496.

Japanese Patent Application Laid-open No. 2004-9655 describes that light intensity of a plurality of light-emitting elements included in a plurality of light-emitting element array chips is set such that a comparison result of predetermined image characteristic values in an output image of the light-emitting elements fall within a preset range over an effective image area. Furthermore, the light intensity of the light-emitting elements is set such that a comparison result of the predetermined image characteristic values of the light-emitting elements arranged near ends of the light-emitting element array chips are larger or smaller than those of the other light-emitting elements.

Thus, it is possible to achieve an effect that a sharp longitudinal line due to an arrangement error of the array chip and density unevenness on the whole effective area are hardly noticeable.

However, most part of an optical writing head arranged inside an image forming apparatus has a temperature higher than normal temperature (about 20° C.) at an image forming operation. Specifically, the optical writing head is often used while being expanded due to heat higher than the normal temperature.

A conventional technology has a problem that because light-emitting element array chips are arranged such that an arrangement pitch of the light-emitting element array chips becomes a target value at the normal temperature, a magnification error increases due to heat expansion of a circuit board in accordance with an increase in the temperature.

### SUMMARY OF THE INVENTION

It is an object of the present invention to at least partially solve the problems in the conventional technology.

According to an aspect of the present invention, there is provided an optical writing head including a plurality of light-emitting element array chips; a circuit board on which the light-emitting element array chips are mounted; and an imaging element array that focuses light beams emitted from the light-emitting element array chips to form optical spots, wherein the following inequality is satisfied:

$${L}_{1} < \frac{25.4 \times N}{ρ}$$

where L₁ is an arrangement pitch [millimeter] between any adjacent ones of the light-emitting element array chips at normal temperature, ρ is resolution [dot per inch] in a main scanning direction, and N is number of light-emitting points of each of the light-emitting element array chips.

According to another aspect of the present invention, there is provided an optical writing head including a plurality of light-emitting element array chips; a circuit board on which the light-emitting element array chips are mounted; and an imaging element array that focuses light beams emitted from the light-emitting element array chips to form optical spots, wherein the following inequality is satisfied:

$${L}_{2} < \frac{25.4 \times N \times M}{ρ}$$

where L₂ is an arrangement pitch [millimeter] between any uttermost ones of the light-emitting element array chips at normal temperature, ρ is resolution [dot per inch] in a main scanning direction, N is number of light-emitting points of each of the light-emitting element array chips, and M is total number of the light-emitting element array chips.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of a light-emitting diode (LED) optical writing head with 600 dot-per-inch (dpi) resolution according to a first embodiment of the present invention;

FIG. 2 is a graph for explaining change in an arrangement pitch between adjacent light-emitting element array chips shown in FIG. 1 due to temperature;

FIG. 3 is a graph for explaining change in an arrangement pitch between uttermost light-emitting element array chips shown in FIG. 1 due to temperature;

FIG. 4 is a schematic diagram of an LED optical writing head with 1200 dpi resolution according to a second embodiment of the present invention;

FIG. 5 is a graph for explaining change in an arrangement pitch between adjacent light-emitting element array chips shown in FIG. 4 due to temperature;

FIG. 6 is a graph for explaining change in an arrangement pitch between uttermost light-emitting element array chips shown in FIG. 4 due to temperature;

FIG. 7 is a schematic diagram of an example of a conventional image forming apparatus;

FIG. 8 is a schematic diagram of an optical writing unit in which a rod lens array is used, of the image forming apparatus shown in FIG. 7;

FIG. 9A is a schematic diagram of an example of a conventional LED array;

FIG. 9B is a side view of the LED array shown in FIG. 9A;

FIG. 9C is a schematic diagram of a light-emitting element array chip shown in FIG. 9A;

FIG. 10 is a cross sectional view of an example of a conventional rod lens array;

FIG. 11 is a schematic diagram of an example of a conventional roof prism lens array;

FIG. 12 is a schematic diagram of a conventional optical printer including an optical writing head;

FIG. 13 is a schematic diagram for explaining a configuration of an optical writing head of the optical writing head shown in FIG. 12; and

FIG. 14 is a schematic diagram of an example of a conventional image forming apparatus.

### DETAILED DESCRIPTION OF THE PREFERRED EMBODIMENTS

Exemplary embodiments of the present invention are explained in detail below with reference to the accompanying drawings.

The embodiments have the following aspects.

Because most part of an optical writing head arranged inside an image forming apparatus has a temperature higher than the normal temperature at an image forming operation, the light-emitting element array chips are arranged at accurate pitches at a temperature higher than the normal temperature and an absolute value of a magnification error is small at the temperature higher than the normal temperature.

Preferably, the arrangement pitch of light-emitting element array chips is set to be accurate at about an intermediate temperature in a temperature variation range in practical usage whereby the absolute value of the variation error is small.

Preferably, the absolute value of the magnification error is less than 0.1% in consideration of temperature variation in practical usage.

Preferably, a circuit board is provided with improved heat radiation performance, so that heat of a light emitting element upon emission is effectively released, an increase in the temperature of the circuit board is reduced, and the absolute value of the magnification error is small.

An image of a light-emitting point can be formed on a target imaging plane (photosensitive element) at an equivalent magnification.

The absolute value of the magnification error is small in a self-scanning light-emitting element array chip in which a wiring pattern is simple and it is easy to reduce the size of the circuit board while the temperature of the circuit board is easily increased because of a low heat capacity due to the size reduction.

An optical writing unit does not include a mechanical drive unit, resulting in low noise and compact size, so that dots are formed at accurate pitches, and the absolute value of the magnification error is small.

A trouble hardly occurs in an image due to a temperature change at a continuation area of the light-emitting element array chips.

The magnification error is further reduced by additionally arranging a heat control unit for the optical writing head.

The magnification error is further reduced by additionally performing a heat control process for the optical writing head.

The embodiments described below are preferred embodiments of the present invention, and the present invention is not limited to the embodiments. Various variation and modification can be made within a range of variation and modification which a person skilled in the art could easily arrive at.

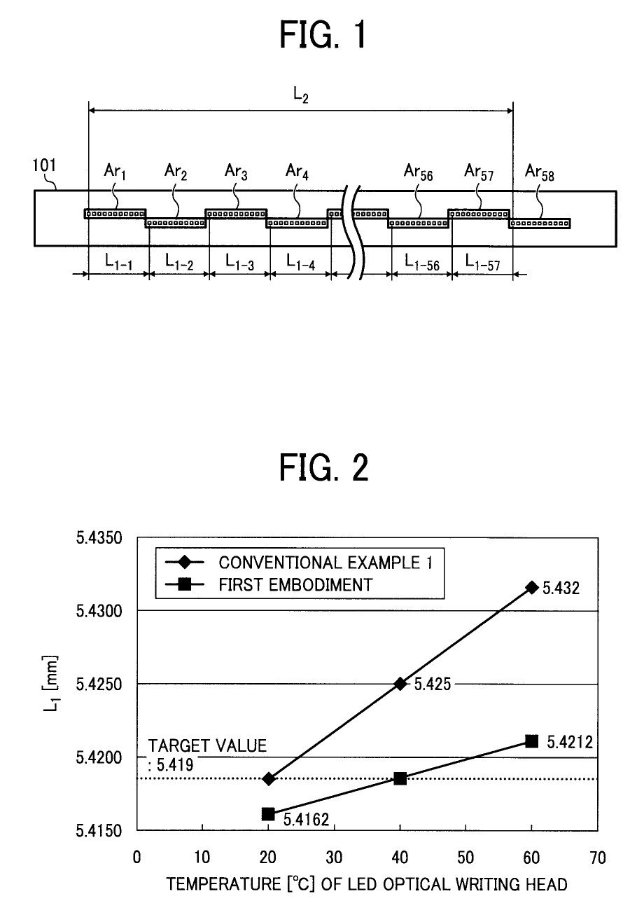

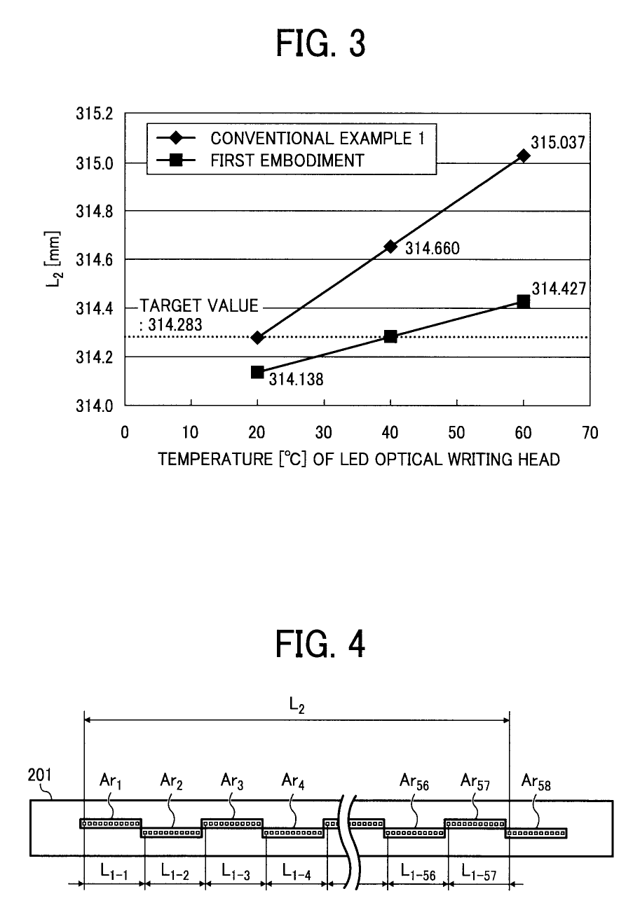

FIG. 1 is a schematic diagram of an LED optical writing head with 600 dpi resolution according to a first embodiment of the present invention. FIG. 2 is a graph for explaining change in an arrangement pitch L₁ due to temperature according to the first embodiment. FIG. 3 is a graph for explaining change in an arrangement pitch L₂ due to temperature according to the first embodiment.

The configuration of the LED optical writing head according to the first embodiment can be, for example, the one shown in FIG. 8 or the one shown in FIG. 13.

The LED optical writing head has 600 dpi resolution for a print sheet of A3 size (about 300 millimeters (mm) in width).

The LED optical writing head includes a circuit board 101 and light-emitting element array chips Ar₁ to Ar₅₈. The light-emitting element array chips Ar₁ to Ar₅₈ each of which has linearly-arranged 128 light-emitting points are linearly arranged on the circuit board 101.

An arrangement pitch between the leftmost light-emitting points of the light-emitting element array chips Ar₁ and Ar₂ in FIG. 1 is denoted by L₁₋₁. An arrangement pitch between the leftmost light-emitting points of the light-emitting element array chips Ar₂ and Ar₃ in FIG. 1 is denoted by L₁₋₂. In the same manner, an arrangement pitch between the leftmost light-emitting points of the adjacent light-emitting element array chips in FIG. 1 is denoted by L₁₋₃, L₁₋₄, . . . , and L₁₋₅₇, in order from the left side in FIG. 1. The light-emitting element array chips Ar₁ to Ar₅₈ are arranged such that all of the arrangement pitches L₁₋₁, L₁₋₂, . . . , and L₁₋₅₇ satisfy Inequality (1):

$${L}_{1} < \frac{25.4 \times N}{ρ} \qquad ( 1 )$$

where ρ is resolution [dot per inch] of the optical writing head in a main scanning direction, and N is the number of the light-emitting points of each of the light-emitting element array chips Ar₁ to Ar₅₈.

According to Inequality (1), when N=128 and ρ=600 dpi, the light-emitting element array chips Ar₁ to Ar₅₈ are arranged such that all of the arrangement pitches L₁₋₁ to L₁₋₅₇ on the circuit board 101 at normal temperature (about 20° C.) are smaller than 5.419 mm.

Moreover, the light-emitting element array chips Ar₁ and Ar₅₈ are arranged such that an arrangement pitch L₂ between the leftmost light-emitting element array chip Ar₁ and the rightmost light-emitting element array chip Ar₅₈, specifically, between the leftmost light-emitting points of the light-emitting element array chip Ar₁ and Ar₅₈, in FIG. 1 satisfies Inequality (2):

$${L}_{2} < \frac{25.4 \times N \times M}{ρ} \qquad ( 2 )$$

where M is total number of the light-emitting element array chips.

According to Inequality (2), when N=128, M=58, and ρ=600 dpi, the light-emitting element array chips Ar₁ and Ar₅₈ are arranged such that the arrangement pitch L₂ at the normal temperature (about 20° C.) is smaller than 314.283 mm.

Furthermore, it is preferable that when a highest temperature Tₕ of the LED optical writing head in practical usage is 60° C., the light-emitting element array chips Ar₁ to Ar₅₈ be arranged such that all of the arrangement pitches L₁₋₁ to L₁₋₅₇ at the normal temperature (about 20° C.) roughly satisfy Inequality (3):

$${L}_{1} < \frac{\frac{25.4 \times N}{ρ}}{1 + ( α \times ( \frac{{T}_{h} - 20}{2} ) )} \qquad ( 3 )$$

where α is a linear expansion coefficient [/° C.] of the circuit board 101.

According to Inequality (3), when N=128, ρ=600 dpi, α=2.3×10⁻⁵/° C., and Tₕ=60° C., the light-emitting element array chips Ar₁ to Ar₅₈ are arranged such that all of the arrangement pitches L₁₋₁ to L₁₋₅₇ on the circuit board 101 at the normal temperature (about 20° C.) is about 5.4162 mm.

Furthermore, it is preferable that when Tₕ=60° C., the leftmost light-emitting element array chip Ar₁ and the rightmost light-emitting element array chip Ar₅₈ be arranged such that the arrangement pitch L₂ satisfy Inequality (4):

$${L}_{2} < \frac{\begin{matrix}25.4 \times N \times M \\ ρ\end{matrix}}{1 + ( α \times ( \frac{{T}_{h} - 20}{2} ) )} \qquad ( 4 )$$

According to Inequality (4), when N=128, M=58, ρ=600 dpi, α=2.3×10⁻⁵/° C., and Tₕ=60° C., the light-emitting element array chips Ar₁ to Ar₅₈ are arranged such that the arrangement pitch L₂ at the normal temperature (about 20° C.) is about 314.138 mm.

Table 1 shows values used for obtaining the graphs shown in FIGS. 2 and 3.

TABLE 1

| | | | Conventional example 1 | | | First embodiment | | |
|---|---|---|---|---|---|---|---|---|
| Item | Symbol | Unit | 20° C. | 40° C. | 60° C. | 20° C. | 40° C. | 60° C. |
| Resolution | ρ | dpi | 600 | 600 | 600 | 600 | 600 | 600 |
| Number of light-emitting | N | number | 128 | 128 | 128 | 128 | 128 | 128 |
| points of light-emitting | | | | | | | | |
| array chip | | | | | | | | |
| Number of light-emitting | M | number | 58 | 58 | 58 | 58 | 58 | 58 |
| array chips | | | | | | | | |
| Linear expansion | α | /° C. | 6.0E−05 | 6.0E−05 | 6.0E−05 | 2.3E−05 | 2.3E−05 | 2.3E−05 |
| coefficient of circuit | | | | | | | | |
| board | | | | | | | | |
| Arrangement pitch | L₁ | mm | 5.4187 | 5.4252 | 5.4317 | 5.4162 | 5.4187 | 5.4212 |
| between adjacent light- | | | | | | | | |
| emitting array chips | | | | | | | | |
| Arrangement pitch | L₂ | mm | 314.283 | 314.660 | 315.037 | 314.138 | 314.283 | 314.427 |
| between uttermost light- | | | | | | | | |
| emitting array chips | | | | | | | | |
| Error of arrangement | — | mm | 0 | 0.377 | 0.754 | −0.145 | 0 | 0.145 |
| pitch L₂ | | | | | | | | |
| Magnification error | — | % | 0.00 | 0.12 | 0.24 | −0.05 | 0.00 | 0.05 |

When the arrangement pitches L₁ is 5.419 that is the target value shown in FIG. 2, the magnification error upon a printing operation is zero. In the conventional example 1, an error from the target value is zero at the temperature of about 20° C., and the error from the target value increases as the temperature increases.

On the other hand, in the first embodiment, the magnification error is zero at an intermediate temperature (about 40° C.) between the highest temperature Tₕ (about 60° C.) in practical usage and the normal temperature (about 20° C.), and the error is the largest at the normal temperature (about 20° C.) and the highest temperature Tₕ (about 60° C.) When the arrangement pitch L₂ is 314.283 that is the target value shown in FIG. 3, the magnification error is zero. In the same manner as shown in FIG. 2, in the conventional example 1, the error from the target value is zero at the temperature of about 20° C., and the error from the target value increases as the temperature increases.

On the other hand, in the first embodiment, the magnification error is zero at the intermediate temperature (about 40° C.) between the highest temperature Tₕ (about 60° C.) in practical usage and the normal temperature (about 20° C.), and the error is the largest at the normal temperature (about 20° C.) and the highest temperature Tₕ (about 60° C.)

The magnification error upon a printing operation on an original is required to be small in an image forming apparatus employing the above LED optical writing head. While the magnification error of the image forming apparatus is required to be about less than 0.3% to 0.5%, the magnification error of the LED optical writing head is required to be less than 0.1%. The magnification error mainly depends on the linear expansion coefficient α of the circuit board 101.

In the first embodiment, the magnification is set to one at the intermediate temperature (about 40° C.) between the normal temperature (about 20° C.) and the highest temperature Tₕ (about 60° C.) in practical usage. Because the error is the largest at the normal temperature (about 20° C.) and the highest temperature Tₕ (about 60° C.), the error of the arrangement pitch at the normal temperature (about 20° C.) and the highest temperature Tₕ (about 60° C.) is desired to be less than 0.1%.

In the first embodiment, the magnification error is less than 0.1% in a range where the linear expansion coefficient α satisfies Inequality (5).

Inequality (5) is obtained by modifying and simplifying Inequality (6). The numerator of the right-hand side of Inequality (6) indicates an amount of expansion from the intermediate temperature (about 40° C.) to the highest temperature Tₕ (about 60° C.), and the denominator of the left-hand side of Inequality (6) indicates an arrangement pitch in the intermediate temperature (about 40° C.), i.e., when the magnification error is zero.

$$\begin{matrix}α < \frac{2.0 \times {10}^{- 3}}{{T}_{h} - 20} & ( 5 ) \\ \frac{{L}_{2} \times α \times ( \begin{matrix}{T}_{h} - 20 \\ 2\end{matrix} )}{{L}_{2} + {L}_{2} \times α \times ( \begin{matrix}{T}_{h} - 20 \\ 2\end{matrix} )} < 0.001 & ( 6 )\end{matrix}$$

A base material of the circuit board 101 is selected such that the linear expansion coefficient α of the base material satisfies Inequality (5).

According to Inequality (5), when Tₕ=60° C., a material having the linear expansion coefficient α of less than 5×10⁻⁵ [/° C.] is selected for the circuit board 101.

A glass epoxy board used in the conventional example 1 has the linear expansion coefficient of about 6.0×10⁻⁵ [/° C.], which results in a large magnification error, and therefore it does not satisfy the condition in Inequality (5).

On the other hand, when the circuit board 101 is formed of a metal-base printed board, it can satisfy the condition in Inequality (5).

A base material of the circuit board 101 is aluminum alloy, and in the graphs in FIGS. 2 and 3 and Table 1, the arrangement pitch L₂ is calculated where the linear expansion coefficient α is 2.3×10⁻⁵ [/° C.].

While the largest error of the arrangement pitch L₂ in the conventional example 1 is 0.754 mm, the largest error of the arrangement pitch L₂ in the first embodiment is 0.145 mm, which is about one fifth of the error of the arrangement pitch L₂ in the conventional example 1.

The light-emitting points are arranged on the light-emitting element array chip with an arrangement pitch L₀ of 25.4/600=42.3 micrometers (μm) (0.0423 mm) with disregard to expansion caused due to an increase in temperature. Because an absolute value of an amount of thermal expansion of the light-emitting element array chip that is a semiconductor element due to an increase in temperature is small, it is not necessary to set the arrangement pitch Lo to be small at the normal temperature.

As shown in FIG. 2, because the arrangement pitch L₁ between the adjacent light-emitting element array chips on the circuit board 101 changes in accordance with the temperature, it is preferable to arrange a light-intensity adjusting unit that adjusts a light intensity corresponding to the temperature of the circuit board 101. For example, it is preferable that the light intensity adjustment be performed such that a line width of two dots formed across the light-emitting element array chips is the same as that of two dots not formed across the light-emitting element array chips. A temperature sensor can be arranged on the circuit board 101.

Furthermore, a heater can be arranged as a heating unit for a heating process at the start time of the operation of the LED optical writing head.

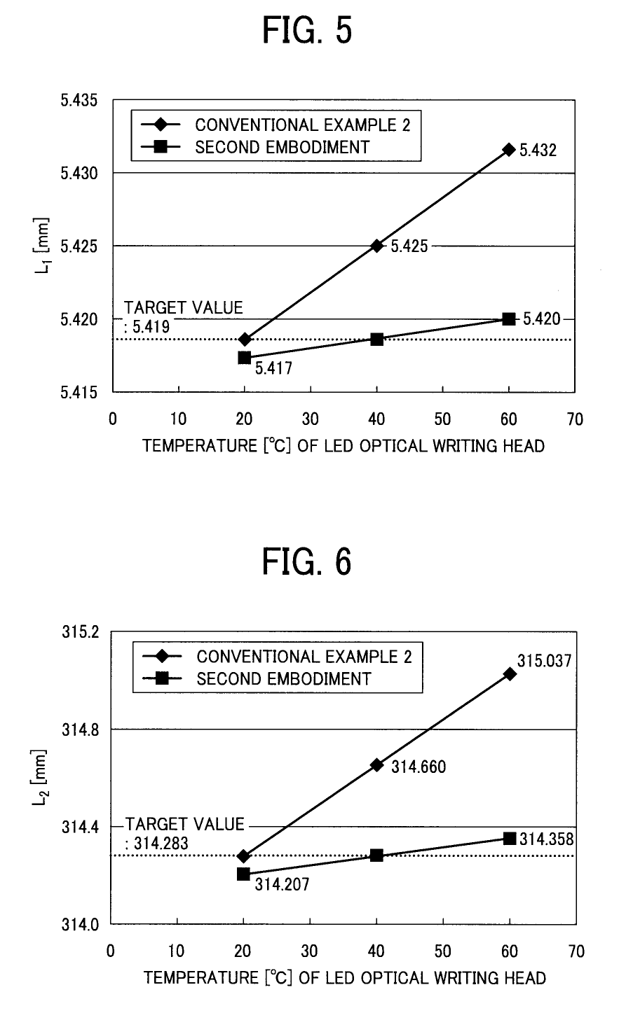

FIG. 4 is a schematic diagram of an LED optical writing head with 1200 dpi resolution according to a second embodiment of the present invention. FIG. 5 is a graph for explaining change in the arrangement pitch L₁ due to temperature according to the second embodiment. FIG. 6 is a graph for explaining change in the arrangement pitch L₂ due to temperature according to the second embodiment.

The same components as those in the first embodiment are indicated by the same reference numerals in the second embodiment.

In the second embodiment, the number of the light-emitting points arranged in the light-emitting element array chip is 256, which is twice as many as that in the first embodiment.

A zinc steel sheet having a lower linear expansion coefficient than aluminum alloy is used as a base material of a circuit board 201.

The LED optical writing head according to the second embodiment has 1200 dpi resolution for a print sheet of A3 size (about 300 mm in width).

On the circuit board 201, the light-emitting element array chips Ar₁ to Ar₅₈ each of which has linearly-arranged 256 light-emitting points are linearly arranged.

The light-emitting element array chips Ar₁ to Ar₅₈ are arranged such that all of the arrangement pitches L₁₋₁, L₁₋₂, . . . , and L₁₋₅₇ in FIG. 4 satisfy Inequality (1).

According to Inequality (1), when N=256 and ρ=1200 dpi, the light-emitting element array chips Ar₁ to Ar₅₈ are arranged such that all of the arrangement pitches L₁₋₁ to L₁₋₅₇ on the circuit board 201 at the normal temperature (about 20° C.) is smaller than 5.419 mm.

Moreover, the light-emitting element array chips Ar₁ and Ar₅₈ are arranged such that the arrangement pitch L₂ between the leftmost light-emitting element array chip Ar₁ and the rightmost light-emitting element array chip Ar₅₈, specifically, between the leftmost light-emitting points of the light-emitting element array chip Ar₁ and Ar₅₈, in FIG. 4 satisfies Inequality (2).

According to Inequality (2), when N=256, M=58, and ρ=1200 dpi, the light-emitting element array chips Ar₁ and Ar₅₈ are arranged such that the arrangement pitch L₂ at the normal temperature (about 20° C.) is smaller than 314.283 mm.

Furthermore, it is preferable that when the highest temperature Tₕ of the LED optical writing head in practical usage is 60° C., the light-emitting element array chips Ar₁ to Ar₅₈ be arranged such that all of the arrangement pitches L₁₋₁ to L₁₋₅₇ at the normal temperature (about 20° C.) roughly satisfy Inequality (3).

According to Inequality (3), when N=256, ρ=1200 dpi, α=1.2×10⁻⁵/° C., and Tₕ=60° C., the light-emitting element array chips Ar₁ to Ar₅₈ are arranged such that all of the arrangement pitches L₁₋₁ to L₁₋₅₇ on the circuit board 201 at the normal temperature (about 20° C.) is about 5.4174 mm.

Furthermore, it is preferable that when Tₕ=60° C., the leftmost light-emitting element array chip Ar₁ and the rightmost light-emitting element array chip Ar₅₈ be arranged such that the arrangement pitch L₂ satisfy Inequality (4).

According to Inequality (4), when N=256, M=58, ρ=1200 dpi, α=1.2×10⁻⁵/° C., and Tₕ=60° C., the light-emitting element array chips Ar₁ to Ar₅₈ are arranged such that the arrangement pitch L₂ at the normal temperature (about 20° C.) be about 314.207 mm.

Table 2 shows values used for obtaining the graphs shown in FIGS. 5 and 6.

TABLE 2

| | | | Conventional example 2 | | | Second embodiment | | |
|---|---|---|---|---|---|---|---|---|
| Item | Symbol | Unit | 20° C. | 40° C. | 60° C. | 20° C. | 40° C. | 60° C. |
| Resolution | ρ | dpi | 1200 | 1200 | 1200 | 1200 | 1200 | 1200 |
| Number of light-emitting | N | number | 256 | 256 | 256 | 256 | 256 | 256 |
| points of light-emitting | | | | | | | | |
| array chip | | | | | | | | |
| Number of light-emitting | M | number | 58 | 58 | 58 | 58 | 58 | 58 |
| array chips | | | | | | | | |
| Linear expansion | α | /° C. | 6.0E−05 | 6.0E−05 | 6.0E−05 | 1.2E−05 | 1.2E−05 | 1.2E−05 |
| coefficient of circuit | | | | | | | | |
| board | | | | | | | | |
| Arrangement pitch | L₁ | mm | 5.4187 | 5.4252 | 5.4317 | 5.4174 | 5.4187 | 5.4200 |
| between adjacent light- | | | | | | | | |
| emitting array chips | | | | | | | | |
| Arrangement pitch | L₂ | mm | 314.283 | 314.660 | 315.037 | 314.207 | 314.283 | 314.358 |
| between uttermost light- | | | | | | | | |
| emitting array chips | | | | | | | | |
| Error of arrangement | — | mm | 0 | 0.377 | 0.754 | −0.075 | 0 | 0.075 |
| pitch L₂ | | | | | | | | |
| Magnification error | — | % | 0.00 | 0.12 | 0.24 | −0.02 | 0.00 | 0.02 |

When the arrangement pitches L₁ is 5.419 that is the target value shown in FIG. 5, the magnification error upon a printing operation is zero. In the conventional example 2, an error from the target value is zero at the temperature of about 20° C., and the error from the target value increases as the temperature increases.

On the other hand, in the second embodiment, the magnification error is zero at the intermediate temperature (about 40° C.) between the highest temperature Tₕ (about 60° C.) in practical usage and the normal temperature (about 20° C.), and the error is the largest at the normal temperature (about 20° C.) and the highest temperature Tₕ (about 60° C.).

When the arrangement pitch L₂ is 314.283 that is the target value shown in FIG. 6, the magnification error is zero. In the same manner as shown in FIG. 5, in the conventional example 2, the error from the target value is zero at the temperature of about 20° C., and the error from the target value increases as the temperature increases.

On the other hand, in the second embodiment, the magnification error is zero at the intermediate temperature (about 40° C.) between the highest temperature Tₕ (about 60° C.) in practical usage and the normal temperature (about 20° C.), and the error is the largest at the normal temperature (about 20° C.) and the highest temperature Tₕ (about 60° C.)

In the same manner as in the first embodiment, the magnification error upon a printing operation on an original is required to be small in an image forming apparatus employing the above LED optical writing head. While the magnification error of the image forming apparatus is required to be about less than 0.3% to 0.5%, the magnification error of the LED optical writing head is required to be less than 0.1%. The magnification error mainly depends on the linear expansion coefficient α of the circuit board 201.

In the second embodiment, the magnification is set to one at the intermediate temperature (about 40° C.) between the normal temperature (about 20° C.) and the highest temperature Tₕ (about 60° C.) in practical usage. Because the error is the largest at the normal temperature (about 20° C.) and the highest temperature Tₕ (about 60° C.), the error of the arrangement pitch at the normal temperature (about 20° C.) and the highest temperature Tₕ (about 60° C.) is desired to be less than 0.1%.

In the second embodiment, the magnification error is less than 0.1% in a range where the linear expansion coefficient α satisfies Inequality (5).

Inequality (5) is obtained by modifying and simplifying Inequality (6). The numerator of the right-hand side of Inequality (6) indicates an amount of expansion from the intermediate temperature (about 40° C.) to the highest temperature Tₕ (about 60° C.), and the denominator of the left-hand side of Inequality (6) indicates an arrangement pitch in the intermediate temperature (about 40° C.), i.e., when the magnification error is zero.

A base material of the circuit board 201 is selected such that the linear expansion coefficient α of the base material satisfies Inequality (5).

According to Inequality (5), when Tₕ=60° C., a material having the linear expansion coefficient α of less than 5×10⁻⁵ [/° C.] is selected for the circuit board 201.

A glass epoxy board used in the conventional example 2 has the linear expansion coefficient of about 6.0×10⁻⁵ [/° C.], which results in a large magnification error, and therefore it does not satisfy the condition in Inequality (5).

On the other hand, when the circuit board 201 is formed of a metal-base printed board, it can satisfy the condition in Inequality (5).

A base material of the circuit board 201 is a zinc steel sheet, and in the graphs in FIGS. 5 and 6 and Table 2, the arrangement pitch L₂ is calculated where the linear expansion coefficient α is 1.2×10⁻⁵ [/° C.].

While the largest error of the arrangement pitch L₂ in the conventional example 2 is 0.754 mm, the largest error of the arrangement pitch L₂ in the second embodiment is 0.075 mm, which is about one tenth of the error of the arrangement pitch L₂ in the conventional example 2.

In the same manner as in the first embodiment, the light-emitting points are arranged on the light-emitting element array chip with the arrangement pitch L₀ of 25.4/1200=21.2 μm (0.0212 mm) with disregard to expansion caused due to an increase in temperature.

Because an absolute value of an amount of thermal expansion of the light-emitting element array chip that is a semiconductor element due to an increase in temperature is small, it is not necessary to set the arrangement pitch L₀ to be small at the normal temperature.

Although the LED optical writing heads with 600 dpi resolution and 1200 dpi resolution are explained in the first and the second embodiments, the present invention can be applied to an LED optical writing head with higher resolution, such as 2400 dpi or 4800 dpi resolution.

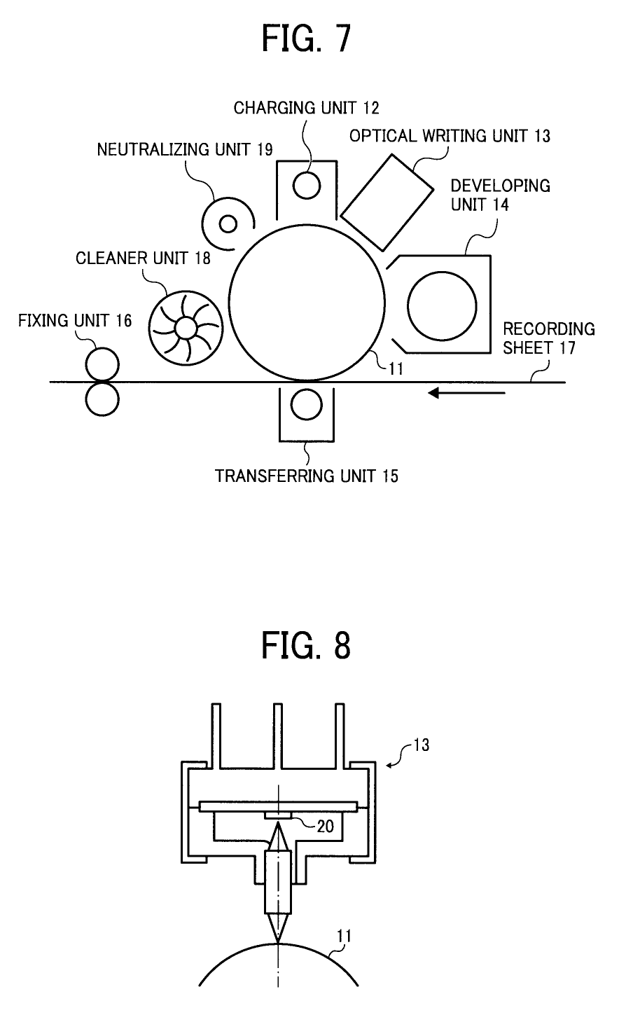

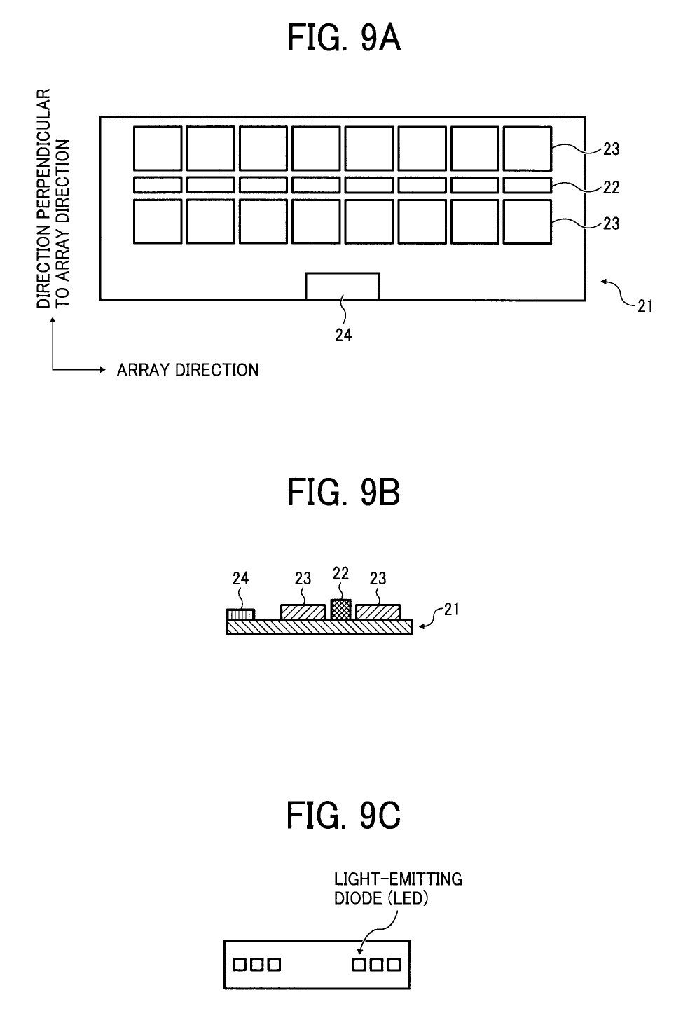

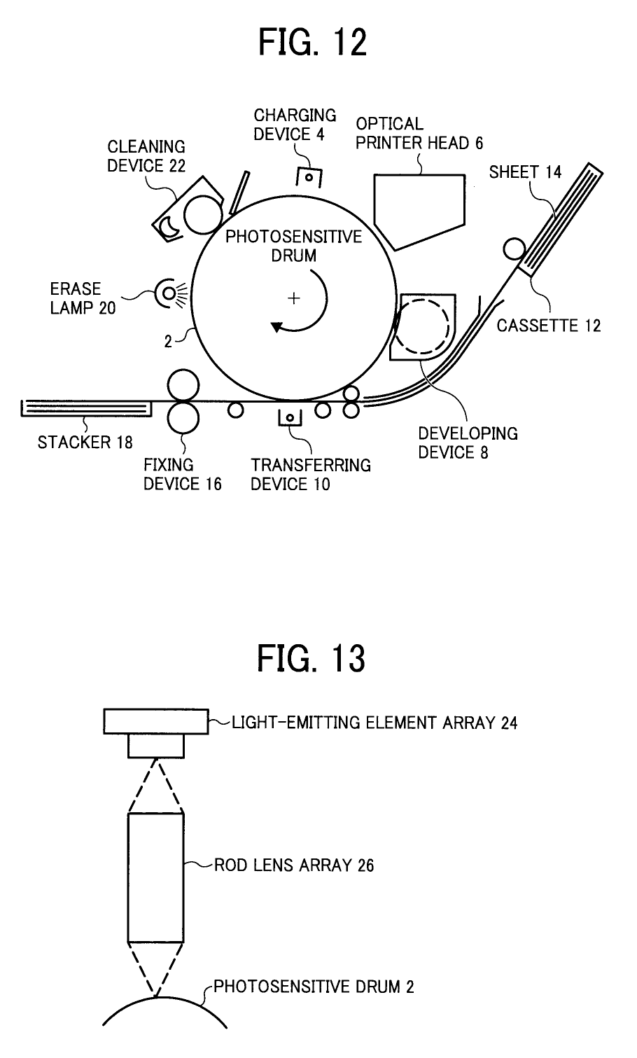

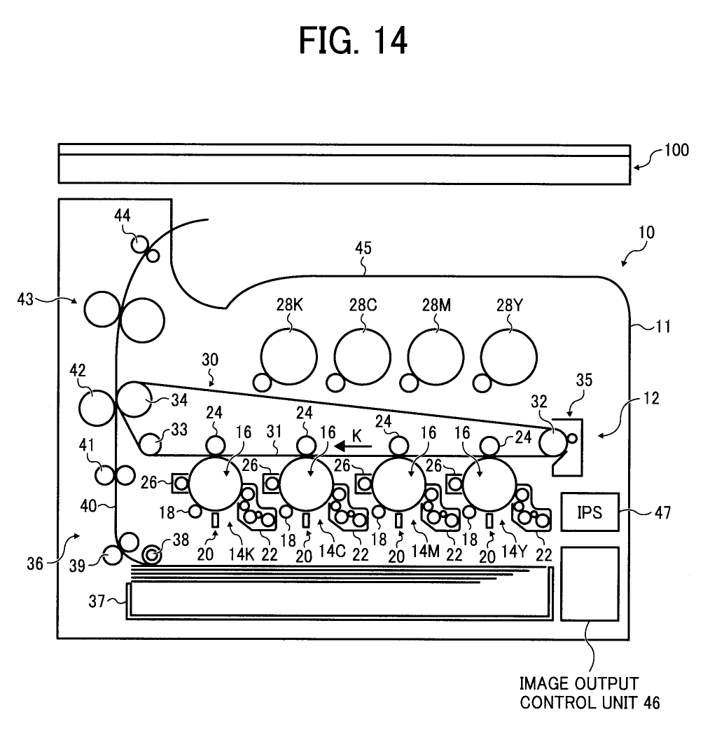

FIG. 14 is a schematic diagram of an image forming apparatus disclosed in Japanese Patent Application Laid-open No. 2006-263985. The LED optical writing heads according to the first and the second embodiments can be applied to the image forming apparatuses shown in FIG. 7, FIG. 12, and FIG. 14.

The explanations of the above image forming apparatuses are omitted because the difference between them is only the configuration of the circuit board of the LED optical writing head.

Compared with an image forming apparatus including an optical scanning device using a polygon mirror and a polygon motor, an image forming apparatus that includes an optical writing unit including an LED optical writing head can achieve lower noise and more compact size because the optical writing unit does not generate mechanical noises and capacity occupied by the optical writing unit can be reduced.

Moreover, the use of the LED optical writing head according to the first or the second embodiment makes it possible to provide an image forming apparatus in which dots are formed at accurate pitches and an absolute value of the magnification error is small.

If the LED optical writing head according to the embodiments is applied to an image forming apparatus, because the arrangement pitch L₁ changes in accordance with the temperature as shown in FIGS. 2 and 5, it is preferable to arrange a light-intensity adjusting unit that adjusts a light intensity corresponding to the temperature of the circuit board.

For example, it is preferable that the light intensity adjustment be performed such that a line width of two dots formed across the light-emitting element array chips is the same as that of two dots not formed across the light-emitting element array chips.

It is possible that a temperature sensor (not shown) is arranged on the circuit board 101 (201), a temperature measured by the temperature sensor is converted into a voltage, and the voltage is used for the light intensity control. In this case, a relation between a temperature and a light intensity to be adjusted can be determined based on an image output or the like to prepare an adjustment function in advance, and the light intensity can be adjusted in accordance with a measured temperature (voltage).

It is also possible that a heater is arranged as a heating unit in the LED optical writing head, so that the LED optical writing head is heated at the start time of operation of the LED optical writing head after the power is turned on. Because the LED optical writing head is heated to a temperature higher than the normal temperature (about 20° C.), it is possible to form an image with a small magnification error.

A heating process can be performed before an image forming process without arranging a particular heating unit in the LED optical writing head.

It is also possible that all of the light-emitting points in the LED optical writing head be continuously kept on for a predetermined time, so that the LED optical writing head is heated by self-heating.

The temperature of the LED optical writing head can be increased by operating a unit (for example, the fixing unit) other than the LED optical writing head to increase the temperature inside the image forming apparatus.

A temperature sensor (not shown) can be arranged on the circuit board 101 (201) and a heating process can be performed to determine whether the temperature of the circuit board 101 is higher than a predetermined temperature thereby controlling the temperature of the circuit board 101. Alternatively, even if the temperature sensor is not arranged on the circuit board 101, the temperature of the circuit board 101 can be controlled based on a time of the heating process or the like.

Because an image forming process is started after the temperature of the LED optical writing head becomes higher than the normal temperature (about 20° C.), it is possible to form an image with a small magnification error.

If the magnification error due to change of the temperature of the LED optical writing head is not acknowledged as a problem, it is possible that a user selects whether the heating process is performed by settings of the image forming apparatus or the like.

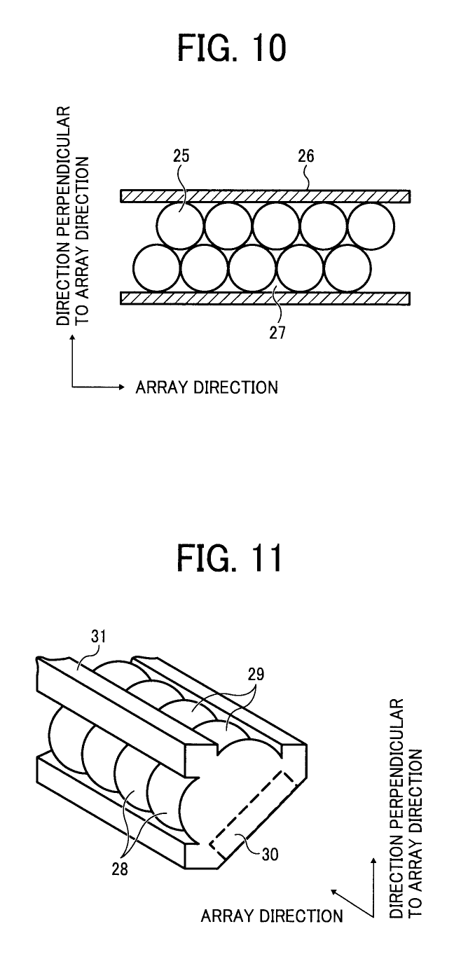

The LED optical writing head according to the above embodiments can employ a rod lens array or a substantially flat plate lens such as the rod lens array shown in FIG. 10 or the RPLA shown FIG. 11.

According to an aspect of the present invention, it is possible to provide an optical writing head and an image forming apparatus in which light-emitting element array chips are arranged at accurate pitches at a temperature higher than a normal temperature.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An optical writing head comprising:
a plurality of light-emitting element array chips;
a circuit board on which the light-emitting element array chips are mounted; and
an imaging element array that focuses light beams emitted from the light-emitting element array chips to form optical spots, wherein
the following inequality is satisfied:
$${L}_{1} < \frac{25.4 \times N}{ρ}$$
where L₁ is an arrangement pitch [millimeter] between any adjacent ones of the light-emitting element array chips at normal temperature, ρ is resolution [dot per inch] in a main scanning direction, and N is number of light-emitting points of each of the light-emitting element array chips.

2. The optical writing head according to claim 1, wherein the following Inequality is satisfied:
$${L}_{1} < \frac{\frac{25.4 \times N}{ρ}}{1 + ( α \times ( \frac{{T}_{h} - 20}{2} ) )}$$
where α is a linear expansion coefficient [/° C.] of the circuit board, and Tₕ is highest temperature [° C.] of the optical writing head in practical usage.

3. The optical writing head according to claim 2, wherein the following Inequality is satisfied:
$$α < \frac{2.0 \times {10}^{- 3}}{{T}_{h} - 20}$$

4. The optical writing head according to claim 3, wherein the circuit board is a metal-base printed board.

5. The optical writing head according to claim 1, wherein the imaging element array is formed of any of a rod lens array and a substantially flat plate lens.

6. The optical writing head according to claim 1, wherein each of the light-emitting element array chips is a self-scanning light-emitting element array chip.

7. An image forming apparatus comprising the optical writing head according to claim 1.

8. The image forming apparatus according to claim 7, further comprising an adjusting unit that adjusts light intensity of nearest light-emitting points of adjacent ones of the light-emitting element array chips depending on a temperature of the circuit board.

9. The image forming apparatus according to claim 7, further comprising a heating unit that heats the optical writing head.

10. The image forming apparatus according to claim 7, wherein the image forming apparatus performs a heating process to heat the optical writing head to a temperature higher than a normal temperature before performing an image forming process.

11. An optical writing head comprising:
a plurality of light-emitting element array chips;
a circuit board on which the light-emitting element array chips are mounted; and
an imaging element array that focuses light beams emitted from the light-emitting element array chips to form optical spots, wherein
the following inequality is satisfied:
$${L}_{2} < \frac{25.4 \times N \times M}{ρ}$$
where L₂ is an arrangement pitch [millimeter] between any uttermost ones of the light-emitting element array chips at normal temperature, ρ is resolution [dot per inch] in a main scanning direction, N is number of light-emitting points of each of the light-emitting element array chips, and M is total number of the light-emitting element array chips.

12. The optical writing head according to claim 11, wherein the following Inequality is satisfied:
$${L}_{2} < \frac{( \begin{matrix}25.4 \times N \times M \\ ρ\end{matrix} )}{1 + ( α \times ( \begin{matrix}{T}_{h} - 20 \\ 2\end{matrix} ) )}$$
where α is a linear expansion coefficient [/° C.] of the circuit board, and Tₕ is highest temperature [° C.] of the optical writing head in practical usage.

13. The optical writing head according to claim 12, wherein the following Inequality is satisfied:
$$α < \frac{2.0 \times {10}^{- 3}}{{T}_{h} - 20}$$

14. The optical writing head according to claim 13, wherein the circuit board is a metal-base printed board.

15. The optical writing head according to claim 11, wherein the imaging element array is formed of any of a rod lens array and a substantially flat plate lens.

16. The optical writing head according to claim 11, wherein each of the light-emitting element array chips is a self-scanning light-emitting element array chip.

17. An image forming apparatus comprising the optical writing head according to claim 11.

18. The image forming apparatus according to claim 17, further comprising an adjusting unit that adjusts light intensity of nearest light-emitting points of adjacent ones of the light-emitting element array chips depending on a temperature of the circuit board.

19. The image forming apparatus according to claim 17, further comprising a heating unit that heats the optical writing head.

20. The image forming apparatus according to claim 17, wherein the image forming apparatus performs a heating process to heat the optical writing head to a temperature higher than a normal temperature before performing an image forming process.
